(19) United States
(12) Patent Application Publication
(10) Pub. No.: US 2015/0173379 A1
(43) Pub. Date: Jun. 25, 2015

(54) HORMESIS INDUCING DEVICE FOR FRUITS AND VEGETABLES

(71) Applicant: Seoul Viosys Co., Ltd., Ansan-si (KR)

(72) Inventors: Seong Min Lee, Ansan-si (KR); Young Hwan Son, Ansan-si (KR); Daewoong Suh, Ansan-si (KR)

(73) Assignee: Seoul Viosys Co., Ltd., Ansan-si (KR)

(21) Appl. No.: 14/405,780

(22) PCT Filed: Jun. 4, 2013
(86) PCT No.: PCT/KR2013/004889

§ 371 Date: Dec. 4, 2014

(30) Foreign Application Priority Data
Jun. 4, 2012 (KR) 10-2012-0059760

(51) Int. Cl. A23B 7/015; G05B 15/02

(52) U.S. Cl. CPC A23B 7/015; G05B 15/02

(57) ABSTRACT

Provided is a hormesis inducing device for fruits and vegetables that includes: a control unit which determines the strength of stimulus according to biological information about the fruits and vegetables that are harvested or growing and which controls at least one from among a kind of light, a quantity of the light, an irradiation time of the light, a wavelength of the light, and a temperature based on the determined strength of the stimulus; and a stimulus generation unit which applies light to the fruits and the vegetables based on the determined strength of the stimulus or adjusts and applies the temperature. Thereby, individually optimized hormesis inducing conditions can be provided for various kinds of vegetables and fruits.

### TECHNICAL FIELD

The present invention relates to a hormesis inducing device for fruits and vegetables and, more particularly, to a hormesis inducing device for fruits and vegetables that are harvested or growing using an ultraviolet light-emitting diode (UV LED).

### BACKGROUND ART

Organisms have a stimulus-response mechanism that protects themselves against a low level of external stress. The stimulus-response mechanism is specifically activated when the organism is exposed to specific external stress, and generally produces innate biological defense materials that cause the organism to have tolerance to external stresses. In this way, a positive phenomenon that an optimum quantity of external stress would rather activate the stimulus-response mechanism of the organism to improve the tolerance to the external stresses than threaten survival of the organism is referred to as hormesis.

It has recently been found that many of the innate biological defense materials which the organism produces due to the hormesis phenomenon as described above are also useful to health of human beings. Thus, studies of production of health functional materials using mechanisms of organisms themselves are actively under way. Especially, the results of studies that have improved a content of the health functional material by irradiating a plant with ultraviolet rays using an ultraviolet lamp attract attention of the academic world in the aspect of efficiency. These studies suggest that health functionality and usefulness of vegetables and fruits that are harvested or growing can be further improved by applying the hormesis phenomenon based on the ultraviolet rays to the vegetables and fruits.

However, in the case of the ultraviolet lamp used in the studies, there is a limitation to application to the vegetables and fruits stored in a closed space due to heat generated from the lamp. That is, the ultraviolet lamp generates a lot of heat along with emission of the rays, and the heat emitted into the closed space is trapped without escaping from the space. In this way, the trapped heat affects vegetables and fruits that are harvested and stored or that are growing in a hothouse such as a greenhouse as another external stress, and causes a problem that deteriorates production efficiency of the desired health functional materials or produces unexpected third materials. Further, due to the heat continuously accumulated in the closed space, nutrients vulnerable to the heat, including proteins in the vegetables and fruits, are denatured and destroyed to reduce freshness or eating quality of the vegetables and fruits. In addition, in the case of the ultraviolet lamp, the emitted ultraviolet rays are wide in wavelength width, and thus inducing efficiency of the hormesis is reduced even when the vegetables and fruits are irradiated with the ultraviolet rays.

For this reason, it is predicted that there is a need to develop a hormesis inducing device for vegetables and fruits, which is capable of maximizing hormesis inducing efficiency by minimizing an influence caused by the heat while radiating ultraviolet rays of specific wavelengths in irradiating the vegetables and fruits that are harvested or growing with the ultraviolet rays to induce hormesis.

### DISCLOSURE

### Technical Problem

Accordingly, the present invention has been made in an effort to solve the problems occurring in the related art, and an object of the present invention is to provide a hormesis inducing device for fruits and vegetables in which a hormesis phenomenon is induced in the fruits and vegetables using ultraviolet rays, thereby making it possible to improve contents of health functional materials in the fruits and vegetables.

### Technical Solution

In order to achieve the above object, according to one aspect of the present invention, there is provided a hormesis inducing device for fruits and vegetables which includes: a control unit that determines strength of stimulus according to biological information about fruits and vegetables that are harvested or growing and controls at least one of a kind, quantity, irradiation time, wavelength, and temperature of light based on the determined strength of stimulus; and a stimulus generation unit configured to irradiate the fruits and vegetables with the light or to adjust and apply the temperature based on the determined strength of stimulus.

### Advantageous Effects

The hormesis inducing device for fruits and vegetables of the present invention applies ultraviolet stress to the fruits and vegetables, and induces hormesis to improve contents of health functional materials in the fruits and vegetables. Furthermore, the hormesis inducing device for fruits and vegetables of the present invention can properly control outside a kind, quality, or irradiation time of irradiated light, or a temperature, so that individually optimized hormesis inducing conditions can be provided for various kinds of vegetables and fruits.

However, the technical effects of the present invention are not limited to the above disclosure, and other technical effects may become apparent to those of ordinary skill in the art based on the following descriptions.

### DESCRIPTION OF DRAWINGS

FIG. 1 is a perspective view illustrating a hormesis inducing device for fruits and vegetables according to a first embodiment of the present invention;

FIG. 2 is a cross-sectional view taken along line I-I′ of FIG. 1;

FIG. 3 is a perspective view illustrating a hormesis inducing device for fruits and vegetables according to a second embodiment of the present invention;

FIG. 4 is a cross-sectional view taken along line II-II′ of FIG. 3;

FIG. 5 is a conceptual block diagram illustrating a hormesis inducing device for fruits and vegetables according to an embodiment of the present invention; and

FIG. 6 illustrates a configuration of a greenhouse having a hormesis inducing device for fruits and vegetables according to a third embodiment of the present invention.

### BEST MODE

The terminology used herein is for the purpose of describing particular embodiments only and is not intended to be limiting of example embodiments.

Further, in the drawings, the thicknesses of layers and regions may be exaggerated for clarity.

As used herein, the singular forms are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

In addition, the terms “module” and “section,” used herein are given or mixed in view of easy preparation of the specification only, and do not have meanings or functions distinguished from each other per se.

Further, it will be understood that, although the terms first, second, etc. may be used herein to describe various elements, these elements should not be limited by these terms. These terms are only used to distinguish one element from another. For example, a first element could be termed a second element and, similarly, a second element could be termed a first element, without departing from the scope of example embodiments.

Hereinafter, an exemplary embodiment of the present invention will be described in detail with reference to the accompanying drawings. Throughout the drawings, it is noted that the same reference numerals or letters will be used to designate like or equivalent elements having the same function, and a repetitive description of the like or equivalent elements will be omitted.

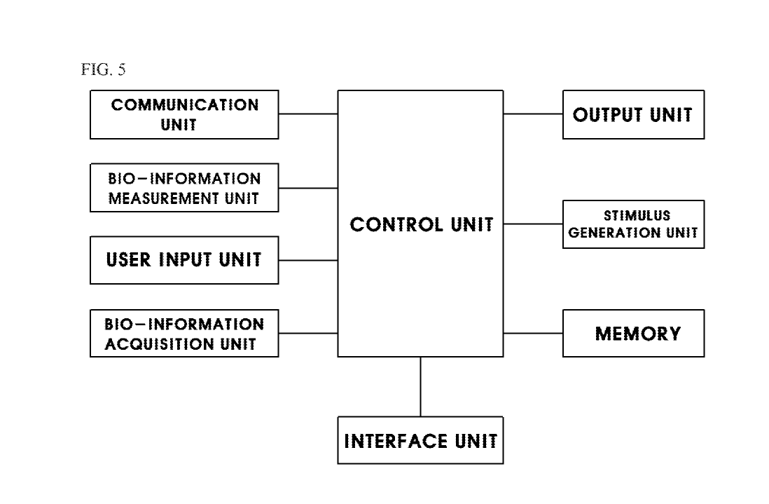

FIG. 5 is a conceptual block diagram illustrating a hormesis inducing device for fruits and vegetables according to an embodiment of the present invention.

The hormesis inducing device for fruits and vegetables includes a control unit and a stimulus generation unit. The hormesis inducing device for fruits and vegetables may further include a bio-information acquisition unit. In addition, the hormesis inducing device for fruits and vegetables may include, but not limited to, at least one of a communication unit, a bio-information measurement unit, a user input unit, an output unit, a memory, and an interface unit. Components illustrated in FIG. 5 are illustrative, and a hormesis inducing device for fruits and vegetables which has more or less components than them may be realized.

The communication unit may include at least one module than enables network communication between the hormesis inducing device for fruits and vegetables and a communication system or between the hormesis inducing device for fruits and vegetables and the bio-information measurement unit.

The communication unit includes a function by which the hormesis inducing device for fruits and vegetables gets access to a network, and may include at least one module than enables communication between the hormesis inducing device for fruits and vegetables and the communication system, between the hormesis inducing device for fruits and vegetables and an output device, or between the hormesis inducing device for fruits and vegetables and the bio-information measurement unit.

For example, the hormesis inducing device for fruits and vegetables may be connected to a separate device such as an output device or a bio-information meter by the communication unit. Further, the communication unit may include an Internet module, a near field communication module, or the other communication means.

The Internet module refers to a module for Internet connection, and may be mounted in or out of the hormesis inducing device for fruits and vegetables.

The near field communication module refers to a module for near field communication.

The bio-information measurement unit may measure, but not limited to, biological information such as kinds of fruits and vegetables, temperatures, kinds and quantities of microorganisms on or in the fruits and vegetables, moisture content, nutrients, freshness, chromaticity, or information about functional materials.

The fruits and vegetables intended for bio-information measurement may include harvested or growing ones. The harvested fruits and vegetables may be subjected to the bio-information measurement in a state in which they are stored in separate storage cases. The growing fruits and vegetables may be subjected to the bio-information measurement in a state in which they are planted in a hothouse such as a greenhouse. For example, the bio-information measurement unit may be implemented as various sensors.

The user input unit generates bio-information data or input data for controlling an operation of the hormesis inducing device for fruits and vegetables, both of which are input by a user. The user input unit may include a key pad, a dome switch, a touch pad (constant voltage/current), a jog wheel, or a jog switch.

The bio-information acquisition unit may acquire the biological information measured by the bio-information measurement unit or the biological information, input by the user, about the harvested or growing fruits and vegetables.

The biological information is information about the target fruits and vegetables, and may include, for instance, kinds of fruits and vegetables, temperatures, kinds and quantities of microorganisms on or in the fruits and vegetables, contents of moisture, nutrients, freshness, chromaticity, or information about functional materials.

The bio-information measurement unit may be mounted in the hormesis inducing device, or independently of the hormesis inducing device. When the bio-information measurement unit is mounted in the hormesis inducing device, the bio-information acquisition unit can directly acquire the biological information measured by the bio-information measurement unit. When the bio-information measurement unit is mounted independently of the hormesis inducing device, the bio-information acquisition unit may acquire the biological information measured by the bio-information measurement unit such as the bio-information meter using the Internet module, the near field communication module, or the other communication means.

The output unit is intended to generate output (display) of information processed in the hormesis inducing device for fruits and vegetables, and may output (display) biological information or strength of stimulus acquired by the hormesis inducing device. The output unit may be mounted in the hormesis inducing device, or independently of the hormesis inducing device.

The output unit may be realized as at least one of a liquid crystal display (LCD), a thin film transistor-liquid crystal display (TFT LCD), an organic light-emitting diode (OLED), a flexible display, a 3D display, and an e-ink display.

The memory can store programs for operations of the control unit (for instance, a method of calculating a difference between the acquired biological information and the target biological information, and a method of deciding the strength of stimulus), and may temporarily store input/output data (for instance, the acquired biological information, the target or set biological information, and information about the strength of stimulus). The memory may include a storage medium selected from at least one of a flash memory type, a hard disk type, a multimedia card micro type, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk.

The interface unit can function as a passage for an external device connected to the hormesis inducing device. The interface unit is adapted to receive data from the external device, is supplied with power so as to distribute the power to each component in the hormesis inducing device, or causes the data (e.g., the biological information and the strength of stimulus) stored in the hormesis inducing device to be transmitted to the external device.

The control unit typically controls overall operations of the hormesis inducing device. Above all, the control unit can calculate the difference between the acquired biological information and the target biological information set to be preferable in order to induce hormesis, and determines the strength of stimulus based on the difference. Thereby, the control unit can control at least one of a kind of light to be irradiated, a quantity of the light, an irradiation time of the light, a wavelength of the light, and a temperature. The control unit may include a light irradiation control unit and a temperature control unit.

The stimulus generation unit is used to irradiate fruits and vegetables with light or to adjust a temperature based on the strength of stimulus determined by the control unit.

In detail, the stimulus generation unit may include a light source unit for controlling a light source to generate light, a heater for increasing a temperature, and a cooler for reducing the temperature. The light source unit may be mounted in the hormesis inducing device in various types. The light source unit may include an ultraviolet light-emitting diode, include one of groups of light-emitting diodes that emit various wavelength bands of light or a combination of two or more groups. These groups of light-emitting diodes may be installed in a module type.

For example, the light source unit may include one or two or more of a first light-emitting diode group emitting a first wavelength band of light, a second light-emitting diode group emitting a second wavelength band of light, a third light-emitting diode group emitting a third wavelength band of light, and a fourth light-emitting diode group emitting a fourth wavelength band of light.

The first to third light-emitting diode groups are configured to have the wavelength bands suitable to induce the hormesis of the fruits and vegetables, and the fourth light-emitting diode group can function to sterilize microorganisms present in the fruits and vegetables.

To be specific, the first light-emitting diode group may include at least one light-emitting diode that emits different wavelengths of light selected from a wavelength band between 320 nm and 400 nm, the second light-emitting diode group may include at least one light-emitting diode that emits different wavelengths of light selected from a wavelength band between 290 nm and 320 nm, the third light-emitting diode group may include at least one light-emitting diode that emits different wavelengths of light selected from a wavelength band between 200 nm and 290 nm, and the fourth light-emitting diode group may include at least one light-emitting diode that emits different wavelengths of light selected from a wavelength band between 595 nm and 600 nm.

Further, the light irradiation control unit of the control unit may include a light selection controller that controls in parallel on/off of electric current applied to the first, second, third, or fourth light-emitting diode group, a light quantity controller that controls in parallel a quantity of the electric current applied to the first, second, third, or fourth light-emitting diode group, and a time controller that controls an application time of the electric current.

Further, the temperature control unit of the control unit may control temperatures around the fruits and vegetables.

### MODE FOR INVENTION

Hereinafter, the present invention will be described in detail based on embodiments. However, the embodiments are merely examples for describing the prevent invention in greater detail, and do not restrict the claimed scope of the present invention.

### First Embodiment

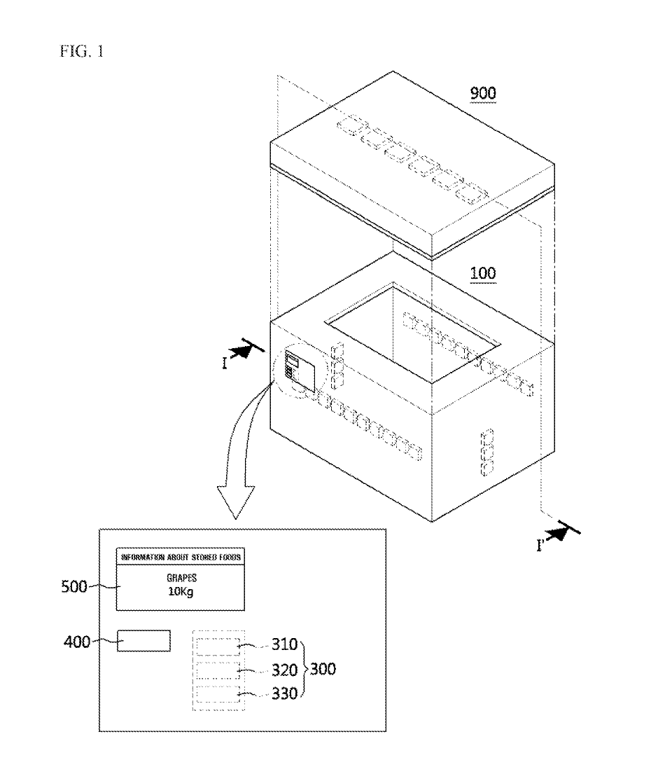

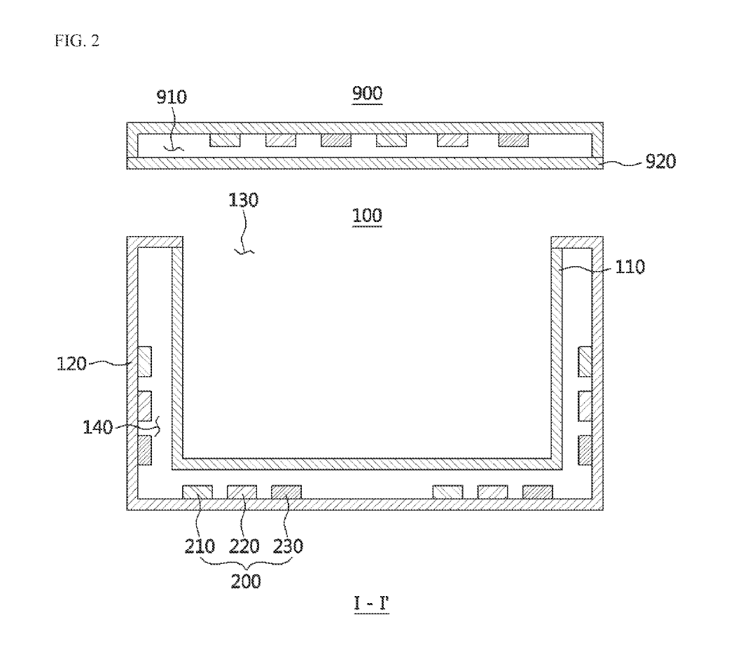

FIG. 1 is a perspective view illustrating a hormesis inducing device for harvested fruits and vegetables according to a first embodiment of the present invention. FIG. 2 is a cross-sectional view taken along line I-I′ of FIG. 1.

Referring to FIGS. 1 and 2, a hormesis inducing device for fruits and vegetables of the present invention includes a storage case 100, a light source unit 200, and a light irradiation control unit 300. As illustrated in FIGS. 1 and 2, the storage case 100 has a reservoir 130 in which fruits and vegetables are contained. The light source unit 200 is disposed in the storage case 100, and selectively radiates different wavelengths of light toward an interior of the reservoir 130, i.e. the fruits and vegetables in the reservoir 130. The light irradiation control unit 300 controls the light source unit 200 according to biological information about the fruits and vegetables contained in the reservoir 130, and controls a kind, quantity, and irradiation time of the light applied toward the reservoir 130 of the storage case 100 by the light source unit 200. That is, in the hormesis inducing device for fruits and vegetables, the light irradiation control unit 300 controls the kind, quantity or irradiation time of the light irradiated by the light source unit 200 according to the biological information about the fruits and vegetables contained in the reservoir 130, thereby inducing hormesis in the fruits and vegetables contained in the reservoir 130 of the storage case 100.

The storage case 100 provides a space in which the fruits and vegetables are contained and the light can be applied to the contained fruits and vegetables, and includes an inner case 110, an outer case 120, and a gap 140.

The inner case 110 is open to at least one side thereof, and thereby the reservoir 130 is formed therein. Thus, the fruits and vegetables can be contained and stored in the reservoir 130. The inner case 110 is preferably formed of a transparent material such that the light derived from the light source unit 200 can be radiated toward the fruits and vegetables in the reservoir 130. Further, the inner case 110 may be formed of a soft material such that the fruits and vegetables stored in the reservoir 130 are not damaged by external physical shocks.

The outer case 120 is formed apart from the inner case 110 so as to surround an outer circumferential surface of the inner case 110. Further, the outer case 120 is partly connected to the inner case 110 so as to physically support the inner case 110. In this way, the two cases 110 and 120 are spaced apart from each other and are partly connected to each other, and thereby the closed gap 140 is defined between the two cases 110 and 120.

One side to which the inner case 110 is open is covered by a cover 900, and thereby an interior of the storage case 100 can be closed tightly. The cover 900 is provided with a gap 910 therein. The cover 900 may be formed of various materials such as plastic. However, one side (bottom side) 920 of the cover 900 which faces the reservoir 130 of the storage case 100 is preferably formed of the transparent material used for the light source unit 200.

The light source unit 200 is disposed inside the storage case 100 and the cover 900. The light source unit 200 radiates light toward the reservoir 130, thereby functioning to induce hormesis in the fruits and vegetables contained in the reservoir 130. Thus, the light source unit 200 is not particularly limited to its position if it can apply the light toward the reservoir 130. In the first embodiment of the present invention, the light source unit 200 is located in the gap 140 of the storage case 100 and the gap 910 of the cover 900, and the light generated from the light source unit 200 transmits the transparent inner case 110 and the transparent bottom side of the cover 900 to the fruits and vegetables of the reservoir 130.

The fruits and vegetables in the reservoir 130 are irradiated with the light generated from the light source unit 200, and the light induces the hormesis. Thus, the light source unit 200 is adapted to selectively radiate the light of wavelengths suitable for the fruits and vegetables according to the biological information of the fruits and vegetables contained in the reservoir 130. That is, the light irradiated by the light source unit 200 of the present invention affects the fruits and vegetables in the reservoir 130 as external stress, and induces the hormesis. Due to this hormesis, the fruits and vegetables are properly increased in content of health functional materials.

Particularly, the light source unit 200 preferably includes an ultraviolet light-emitting diode. Since the ultraviolet light-emitting diode generates remarkably little heat unlike an ultraviolet lamp, it is possible to prevent a decrease in production efficiency of the health functional material which may be generated by the heat or denaturation and destruction of nutrients vulnerable to the heat. Further, the ultraviolet light-emitting diode does not radiate ultraviolet rays whose wavelength widths are wide like the ultraviolet lamp, but ultraviolet rays of specific wavelengths in which full-width-at-half maximum is narrow, to the fruits and vegetables, and thereby hormesis inducing efficiency can be improved.

Further, the light source unit 200 preferably includes ultraviolet light-emitting diodes that can emit various kinds (or wavelengths) of ultraviolet rays. Kinds of biological defense materials generated from plants by stimulus-response mechanisms are different from each other according to a kind of the plant and kinds of the applied ultraviolet rays. Thus, it is necessary to select the kinds of the ultraviolet rays according to the kinds of the fruits and vegetables contained in the reservoir 130 and the kinds of the health functional materials to be increased at the fruits and vegetables. To this end, the light source unit 200 includes a first ultraviolet light-emitting diode group 210 emitting a first wavelength band of light, a second ultraviolet light-emitting diode group 220 emitting a second wavelength band of light, and a third ultraviolet light-emitting diode group 230 emitting a third wavelength band of light, and allows various wavelengths of ultraviolet rays to be selectively radiated to the fruits and vegetables. Especially, in the first embodiment of the present invention, the light source unit 200 is configured in such a manner that the first ultraviolet light-emitting diode group 210 includes at least one of light-emitting diodes emitting different specific wavelengths of light selected from a wavelength band between 320 nm and 400 nm, that the second ultraviolet light-emitting diode group 220 includes at least one of light-emitting diodes emitting different specific wavelengths of light selected from a wavelength band between 290 nm and 320 nm, and the third ultraviolet light-emitting diode group 230 includes at least one of light-emitting diodes emitting different specific wavelengths of light selected from a wavelength band between 200 nm and 290 nm, but it is not limited thereto.

In addition of the kinds of the ultraviolet rays, the kinds of the biological defense materials generated by the stimulus-response mechanism of the plant are different from each other according to a quantity (or intensity) and irradiation time of the applied ultraviolet rays. Thus, it is necessary to properly adjust the quantity (or intensity) and irradiation time of the applied ultraviolet rays according to the kinds of the contained fruits and vegetables including the kinds of the ultraviolet rays radiated by the light source unit 200. To this end, the hormesis inducing device for fruits and vegetables of the present invention may include the light irradiation control unit 300 that controls the irradiated ultraviolet rays according to the information about the contained fruits and vegetables.

The light irradiation control unit 300 controls the kind, quantity, or irradiation time of the ultraviolet rays generated from the light source unit 200 according to the information about the fruits and vegetables contained in the reservoir 130. To this end, the light irradiation control unit 300 includes a light selection controller 310, a light quantity controller 320, and a time controller 330. The light selection controller 310 independently controls on/off of electric current applied to the first, second, or third light-emitting diode group according to the information about the fruits and vegetables contained in the reservoir 130. The light quantity controller 320 independently controls a quantity of the electric current applied to the first, second, or third light-emitting diode group according to the information about the fruits and vegetables contained in the reservoir 130. Further, the time controller 330 controls an application time of the electric current according to the information about the fruits and vegetables contained in the reservoir 130.

The hormesis inducing device for fruits and vegetables may include a fruit and vegetable information input unit 400 that inputs the information such as the kinds, quantities, etc. of the fruits and vegetables contained in the reservoir 130. A difference between fruit and vegetable bio-information input by the fruit and vegetable information input unit 400 and target bio-information is calculated, and the strength of stimulus is determined based on the calculated difference. According to the results, the light irradiation control unit 300 controls the kind, quantity, and irradiation time of the light.

The hormesis inducing device for fruits and vegetables may further include a fruit and vegetable information display unit 500 that displays the information, input by the fruit and vegetable information input unit 400, about the kinds, quantities, etc. of the fruits and vegetables. The fruit and vegetable information display unit 500 may include a liquid crystal display (LCD), a plasma display panel (PDP), a light-emitting diode, a laser diode, or a touch screen. Alternatively, the fruit and vegetable information display unit 500 may be omitted according to circumstances.

### Second Embodiment

It is known that a stimulus-response mechanism of an organism, particularly a plant, to ultraviolet rays more effectively works under cold stress of a lower temperature than room temperature. Thus, a temperature in the space in which the fruits and vegetables are stored is prevented from getting higher that the mom temperature, and the cold stress is properly applied according to the kinds of the stored fruits and vegetables. Thereby, it is possible to improve the efficiency of producing the biological defense material of the plant.

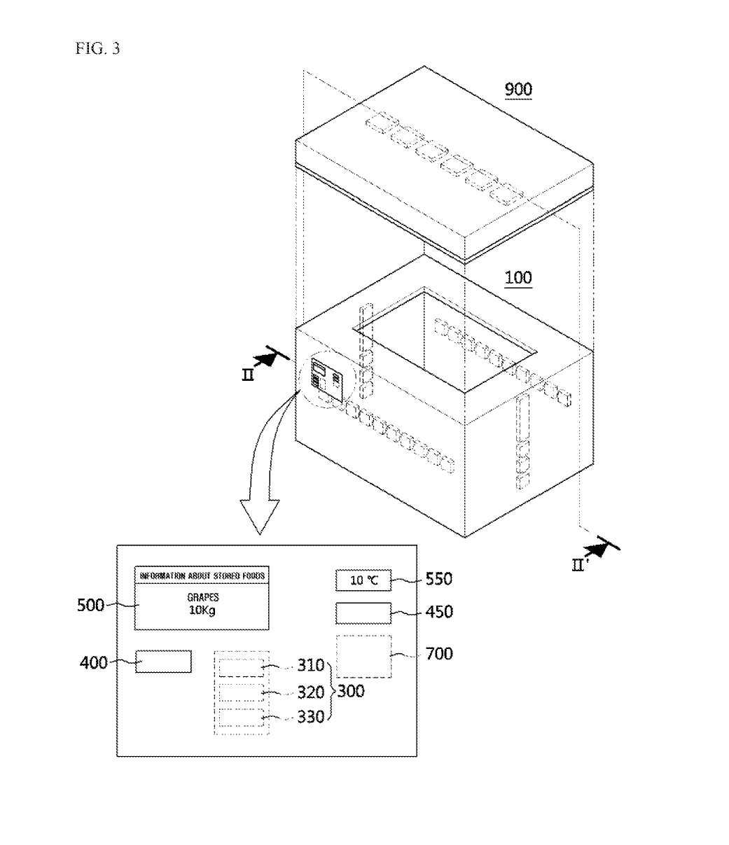

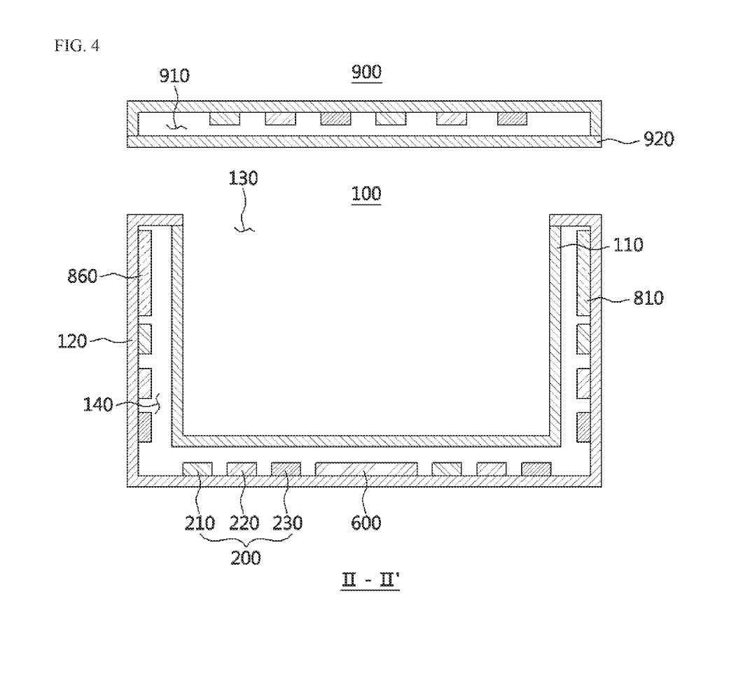

FIG. 3 is a perspective view illustrating a hormesis inducing device for fruits and vegetables according to a second embodiment of the present invention. FIG. 4 is a cross-sectional view taken along line II-II′ of FIG. 3.

A hormesis inducing device for fruits and vegetables according to a second embodiment of the present invention further includes components capable of applying cold stress to the hormesis inducing device for fruits and vegetables which applies the ultraviolet stress according to the first embodiment. Referring to FIG. 3, the hormesis inducing device for fruits and vegetables of the present invention may further include a temperature sensor unit 600, a cooler 810, a heater 860, a temperature information input unit 450, a temperature information display unit 550, and a temperature control unit 700.

The temperature sensor unit 600 is located in the storage case 100, and collects information about a temperature in the reservoir 130 of the storage case 100. Thus, the temperature sensor unit 600 is not particularly limited to its position if it can measure a temperature in the reservoir 130. In the second embodiment of the present invention, the temperature sensor unit 600 is located in the gap 140 at a lower side of the storage case 100, and collects information about the temperature of the reservoir 130.

The cooler 810 and the heater 860 apply cold stress of an adequate temperature into the reservoir 130. That is, the cooler 810 functions to reduce the temperature in the reservoir 130, whereas the heater 860 functions to raise the temperature in the reservoir 130. Thus, the cooler 810 and the heater 860 are not particularly limited to their positions if they can adjust the temperature in the reservoir 130. In the second embodiment of the present invention, the cooler 810 and the heater 860 are located in the gap 140 at opposite upper sides of the storage case 100.

In this way, when the components (i.e., the temperature sensor unit 600, the cooler 810, and the heater 860) capable of adjusting the temperature in the reservoir 130 of the storage case 100 are added, the hormesis inducing device for fruits and vegetables according to the second embodiment of the present invention may include the temperature information input unit 450, the temperature information display unit 550, and the temperature control unit 700.

The temperature information input unit 450 is a means for inputting information about a setting temperature in the reservoir 130 according to the information about the stored fruits and vegetables.

The temperature control unit 700 compares the temperature information collected by the temperature sensor unit 600 with the temperature information input by the temperature information input unit 450, and controls an operation of one of the heater and the cooler. In detail, when the internal temperature of the reservoir 130 which is collected by the temperature sensor unit 600 is higher than the temperature input by the temperature information input unit 450, the temperature control unit 700 operates the cooler 810. When the internal temperature of the reservoir 130 which is collected by the temperature sensor unit 600 is lower than the temperature input by the temperature information input unit 450, the temperature control unit 700 operates the heater 860. Thus, the cooler 810 and the heater 860 are complementarily operated according to the kinds of the fruits and vegetables in which the hormesis is to be induced, and properly maintain the temperature in the reservoir 130.

The hormesis inducing device for fruits and vegetables may include the temperature information display unit 550 that displays the information about the internal setting temperature of the reservoir 130 which is input by the temperature information input unit 450. Like the fruit and vegetable information display unit 500, the temperature information display unit 550 may include a liquid crystal display (LCD), a plasma display panel (PDP), a light-emitting diode, a laser diode, or a touch screen. Alternatively, the temperature information display unit 550 may be omitted according to circumstances.

### Third Embodiment

The hormesis inducing device for fruits and vegetables of the present invention may be applied to fruits and vegetables that are planted and growing in the soil.

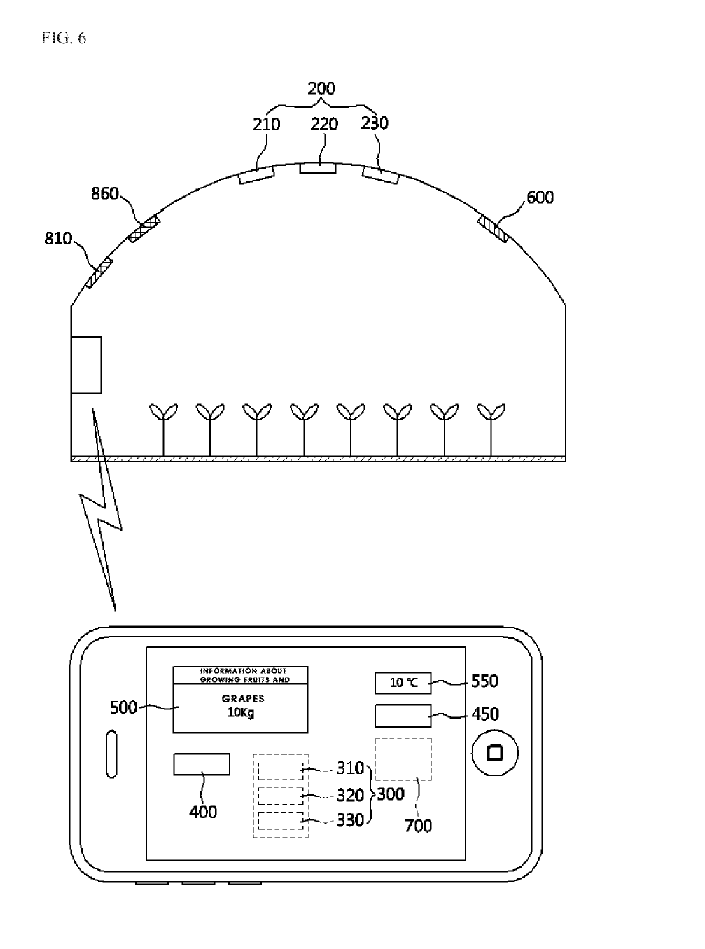

FIG. 6 is a cross-sectional view of a greenhouse mounted with a hormesis inducing device for fruits and vegetables according to a third embodiment of the present invention.

A hormesis inducing device for fruits and vegetables according to a third embodiment of the present invention is to apply to growing fruits and vegetables the configuration of the hormesis inducing device for fruits and vegetables which applies the ultraviolet stress according to the second embodiment. Referring to FIG. 6, the hormesis inducing device for fruits and vegetables of the present invention may include a light source unit 200, a light irradiation control unit 300, a temperature sensor unit 600, a cooler 810, a heater 860, a temperature information input unit 450, a temperature information display unit 550, and a temperature control unit 700.

The light source unit 200, the temperature sensor unit 600, the cooler 810, and the heater 860 may be distributed to a ceiling of the greenhouse. The light source unit 200 is disposed in the greenhouse, and selectively radiates different wavelengths of light toward the inside of the greenhouse and the growing fruits and vegetables. The light irradiation control unit 300 controls the light source unit 200 according to biological information about the fruits and vegetables that are growing in the greenhouse, and controls a kind, quantity, and irradiation time of the light irradiated from the light source unit 200 toward the fruits and vegetables in the greenhouse. That is, in the hormesis inducing device for fruits and vegetables, the light irradiation control unit 300 controls the kind, quantity or irradiation time of the light irradiated by the light source unit 200 according to the biological information about the fruits and vegetables in the greenhouse, thereby inducing hormesis in the fruits and vegetables that are growing in the greenhouse.

The light source unit 200 includes a first light-emitting diode group 210 emitting a first wavelength band of light, a second light-emitting diode group 220 emitting a second wavelength band of light, and a third light-emitting diode group 230 emitting a third wavelength band of light, and allows various wavelengths of ultraviolet rays to be selectively radiated to the fruits and vegetables. The light source unit 200 may further include a fourth light-emitting diode group emitting a fourth wavelength band of light.

The temperature sensor unit 600 collects information about a temperature in the greenhouse. Thus, the temperature sensor unit 600 is not particularly limited to its position if it can measure the temperature in the greenhouse.

The cooler 810 and the heater 860 apply cold stress of a proper temperature into the greenhouse. That is, the cooler 810 functions to reduce the temperature in the greenhouse, whereas the heater 860 functions to raise the temperature in the greenhouse. Thus, the cooler 810 and the heater 860 are not particularly limited to their positions if they can adjust the temperature in the reservoir 130. In the third embodiment of the present invention, the cooler 810 and the heater 860 are located at opposite sides of the ceiling of the greenhouse.

In this way, when the components (i.e., the temperature sensor unit 600, the cooler 810, and the heater 860) capable of adjusting the temperature in the greenhouse are added, the hormesis inducing device for fruits and vegetables according to the third embodiment of the present invention may include the temperature information input unit 450, the temperature information display unit 550, and the temperature control unit 700.

The temperature information input unit 450 is a means for inputting information about a setting temperature in the greenhouse according to the information about the stored fruits and vegetables.

The temperature control unit 700 compares the temperature information collected by the temperature sensor unit 600 with the target or setting temperature information input by the temperature information input unit 450, and controls an operation of one of the heater and the cooler. In detail, when the internal temperature of the greenhouse which is collected by the temperature sensor unit 600 is higher than the target or setting temperature input by the temperature information input unit 450, the temperature control unit 700 operates the cooler 810. When the internal temperature of the greenhouse which is collected by the temperature sensor unit 600 is lower than the temperature input by the temperature information input unit 450, the temperature control unit 700 operates the heater 860. Thus, the cooler 810 and the heater 860 are complementarily operated according to the kinds of the fruits and vegetables in which the hormesis is to be induced, and properly maintain the temperature in the greenhouse.

The hormesis inducing device for fruits and vegetables may include a fruit and vegetable information input unit 400 that inputs the information such as the kinds, quantities, etc. of the fruits and vegetables contained in the reservoir 130. A difference between fruit and vegetable bio-information input by the fruit and vegetable information input unit 400 and target bio-information is calculated, and the strength of stimulus is determined based on the calculated difference. According to the results, the light irradiation control unit 300 controls the kind, quantity, and irradiation time of the light.

The hormesis inducing device for fruits and vegetables may further include a fruit and vegetable information display unit 500 that displays the information, input by the fruit and vegetable information input unit 400, about the kinds, quantities, etc. of the fruits and vegetables. Further, the hormesis inducing device for fruits and vegetables may further include the temperature information display unit 550 that displays the information about the internal setting temperature of the greenhouse which is input by the temperature information input unit 450. The fruit and vegetable information display unit 500 and the temperature information display unit 550 may each include a liquid crystal display (LCD), a plasma display panel (PDP), a light-emitting diode, a laser diode, or a touch screen. Alternatively, the fruit and vegetable information display unit 500 may be omitted according to circumstances.

The biological information measured by the temperature sensor unit 600 may be sent to an external device via an interface by remote control. With this configuration, the light irradiation control unit 300 and the temperature control unit 700 may control the light source unit 200, the cooler 810, and the heater 860, all of which are installed in the greenhouse, by remote control.

In the third embodiment, the fruit and vegetable information input unit 400, the fruit and vegetable information display unit 500, the light irradiation control unit 300, the temperature information input unit 450, the temperature information display unit 550, and the temperature control unit 700 may be disposed outside the greenhouse, and transceive input/output data by remote control to control the temperature in the greenhouse and conditions of the quantity of the irradiated light.

### Examples

As described above, the hormesis inducing device for fruits and vegetables according to the first, second, or third embodiment of the present invention properly adjusts irradiation conditions of the ultraviolet rays and temperature conditions in the reservoir or greenhouse according to the kinds of the fruits and vegetables, and induces the hormesis. Thereby, it is possible to improve the contents of the biological defense material (health functional material) peculiar to each of the fruits and vegetables.

When hormesis is induced in grapes using the hormesis inducing device for fruits and vegetables according to the first, second, or third embodiment of the present invention, ultraviolet rays of 254 nm were radiated with a quantity of light from 1780 μW/cm² to 2300 μW/cm² at room temperature for 30 minutes. Then, the grapes were stored at 0° C. for 10 days, and then at 15° C. for 5 days. When the ultraviolet rays were radiated to induce the hormesis in this way, a content of resveratrol in the grapes was improved by about three times. Since the resveratrol is a material having excellent anti-cancer and antioxidant effects, the grapes in which the hormesis is induced by the ultraviolet rays and cold stress in the hormesis inducing device for fruits and vegetables of the present invention are raised in usefulness as health functional fruits and vegetables.

Further, in the case of mugworts, ultraviolet rays were radiated with 4.2 kJ/m² for 14 days. As a result, a rate of increment of carotenoid showed 44.4 to 55.5%, a rate of increment of antioxidant enzyme activity showed 325%, and a rate of increment of artemisinin showed 1.75 times. Further, an increase in flavonoid was observed.

In the case of tomatoes, ultraviolet rays of 254 nm were radiated with 13.7 kJ/m² for 21 days. As a result, a rate of increment of lycopene reached 1.4 to 1.8 times.

In addition, strawberries showed that antioxidant activity was increased. Mushrooms showed that vitamin D was improved. Sweet basils and peppermints showed that a content of essential oil was increased. Cucumbers showed that a content of phenol and antioxidant activity were increased. Cherries were observed that anthocyanin was increased.

The fruits and vegetables including the grapes given as an example are merely given as an example of using the hormesis inducing device for fruits and vegetables of the present invention. When the conditions of light irradiation and temperature for the other fruits and vegetables are adequately adjusted, the content of the different kinds of health functional materials can be improved.

Although exemplary embodiments of the present invention have been described for illustrative purposes, those skilled in the art will appreciate that various modifications, additions and substitutions are possible, without departing from the scope and spirit of the invention as disclosed in the accompanying claims.

### DESCRIPTION OF THE SYMBOLS AND NUMERALS

100: storage case
110: inner case
120: outer case
130: reservoir
140: gap
200: light source unit
210: first light-emitting diode group
220: second light-emitting diode group
230: third light-emitting diode group
300: light irradiation control unit
310: light selection controller
320: light quantity controller
330: time controller
400: fruit and vegetable information input unit
450: temperature information input unit
500: fruit and vegetable information display unit
550: temperature information display unit
600: temperature sensor unit
700: temperature control unit
810: cooler
860: heater
900: cover
910: gap in cover
920: bottom side of cover

1. A hormesis inducing device for fruits and vegetables comprising:
a control unit that determines strength of stimulus according to biological information about fruits and vegetables that are harvested or growing and controls at least one of a kind, quantity, irradiation time, wavelength, and temperature of light based on the determined strength of stimulus; and
a stimulus generation unit configured to irradiate the fruits and vegetables with the light or to adjust and apply the temperature based on the determined strength of stimulus.

2. The hormesis inducing device according to claim 1, further comprising a bio-information acquisition unit configured to acquire the biological information about the harvested or growing fruits and vegetables, wherein the control unit calculates a difference between the acquired biological information and target biological information.

3. The hormesis inducing device according to claim 1, wherein the biological information includes information about kinds of fruits and vegetables, temperatures, kinds and quantities of microorganisms on or in the fruits and vegetables, moisture content, nutrients, freshness, chromaticity, or functional materials.

4. The hormesis inducing device according to claim 1, further comprising at least one of an output unit that outputs the biological information and the strength of stimulus, an interface unit that transmits the biological information and the strength of stimulus to an external device, a communication unit that is used to be connected to a network, a memory, a user input unit, and a bio-information measurement unit.

5. The hormesis inducing device according to claim 1,
wherein the stimulus generation unit includes a light source unit that selectively radiates different wavelengths of light toward the fruits and vegetables.

6. The hormesis inducing device according to claim 1, further comprising a storage case having a reservoir in which harvested fruits and vegetables are stored, wherein the stimulus generation unit is disposed in the storage case and selectively radiates different wavelengths of light toward the reservoir.

7. The hormesis inducing device according to claim 6, wherein:
the storage case includes an inner case in which the reservoir is formed and one side of which is open, an outer case that is spaced apart from the inner case so as to surround an outer circumferential surface of the inner case, and a gap that is defined by the inner case and the outer case, and
the light source unit is disposed in the gap and applies light into the reservoir.

8. The hormesis inducing device according to claim 6, wherein the inner case is transparent.

9. The hormesis inducing device according to claim 5, wherein the light source unit includes an ultraviolet light-emitting diode.

10. The hormesis inducing device according to claim 5, wherein the light source unit includes one or two or more of a first light-emitting diode group emitting a first wavelength band of light, a second light-emitting diode group emitting a second wavelength band of light, a third light-emitting diode group emitting a third wavelength band of light, and a fourth light-emitting diode group emitting a fourth wavelength band of light.

11. The hormesis inducing device according to claim 10, wherein the first light-emitting diode group includes at least one light-emitting diode that emits different wavelengths of light selected from a wavelength band between 320 nm and 400 nm, the second light-emitting diode group includes at least one light-emitting diode that emits different wavelengths of light selected from a wavelength band between 290 nm and 320 nm, the third light-emitting diode group includes at least one light-emitting diode that emits different wavelengths of light selected from a wavelength band between 200 nm and 290 nm, and the fourth light-emitting diode group includes at least one light-emitting diode that emits different wavelengths of light selected from a wavelength band between 595 nm and 600 nm.

12. The hormesis inducing device according to claim 10, wherein the control unit includes:
a light selection controller that controls in parallel on/off of electric current applied to the first, second, third, or fourth light-emitting diode group;
a light quantity controller that controls in parallel a quantity of the electric current applied to the first, second, third, or fourth light-emitting diode group; and
a time controller that controls an application time of the electric current.

13. The hormesis inducing device according to claim 5, being located at a ceiling or on a sidewall of a greenhouse in which growing fruits and vegetables are planted and further comprising:
a temperature sensor unit that collects information about a temperature in the greenhouse;
a cooler that reduces the temperature in the greenhouse; and
a heater that raises the temperature in the greenhouse.

14. The hormesis inducing device according to claim 6, wherein the storage case further includes:
a temperature sensor unit that collects information about a temperature in the reservoir;
a cooler that reduces the temperature in the reservoir; and
a heater that raises the temperature in the reservoir.

15. The hormesis inducing device according to claim 13, further comprising:
a temperature information input unit that inputs information about a setting temperature in the greenhouse; and
a temperature control unit that compares the temperature information collected by the temperature sensor unit with the temperature information input by the temperature information input unit, and controls an operation of one of the heater and the cooler.

16. The hormesis inducing device according to claim 14, further comprising:
a temperature information input unit that inputs information about a setting temperature in the reservoir; and
a temperature control unit that compares the temperature information collected by the temperature sensor unit with the temperature information input by the temperature information input unit, and controls an operation of one of the heater and the cooler.

17. The hormesis inducing device according to claim 6, wherein the light source unit includes an ultraviolet light-emitting diode.

18. The hormesis inducing device according to claim 6, wherein the light source unit includes one or two or more of a first light-emitting diode group emitting a first wavelength band of light, a second light-emitting diode group emitting a second wavelength band of light, a third light-emitting diode group emitting a third wavelength band of light, and a fourth light-emitting diode group emitting a fourth wavelength band of light.
